(19) United States
(12) Patent Application Publication
(10) Pub. No.: US 2008/0091278 A1
(43) Pub. Date: Apr. 17, 2008

(54) FREIGHT ELEVATOR DOOR CONTROL UTILIZING SERIAL COMMUNICATION

(75) Inventor: Steven P. Reynolds, Toronto (CA)

Correspondence Address: PEARNE & GORDON LLP, 1801 EAST 9TH STREET, SUITE 1200, CLEVELAND, OH, 44114-3108, US

(73) Assignee: THE PEELLE COMPANY LTD., Brampton (CA)

(21) Appl. No.: 11/548,409

(22) Filed: Oct. 11, 2006

(51) Int. Cl. G05B 19/18

(52) U.S. Cl. 700/3

(57) ABSTRACT

A freight elevator door installation including a plurality of vertically sliding landing doors and a vertically sliding car gate, each landing door and said gate being power driven by an associated electrically energized operator, serial communication slave hardware for each landing, and serial communication slave hardware on the car, a serial communication master arranged to receive and send control signals to and from both said landing and car slave hardware, a controller coupled with the serial communication master, a common pair of buss lines in the hoistway connecting each of the landing slaves to the master, the slave hardware for each landing being connected to sensors detecting the open and closed states and locked and unlocked states of the respective landing door and normal and deployed states of an unlocking device of the respective landing door, the slave hardware on the car being connected to sensors detecting the open and closed and locked and unlocked states of the gate and being coupled to the master by lines associated with a travel cable.

### BACKGROUND OF THE INVENTION

The invention relates to equipment and methods for controlling the operation of freight elevator landing doors and car door/gates.

### PRIOR ART

Freight elevators, which term is intended to include inside of the United States service elevators and outside of the United States goods lifts or simply lifts, can have power operated doors on the car and at individual landings. The car door is commonly referred to as a gate reflecting the typical practice of forming it with an open mesh or screen. As it relates to the present disclosure, the word gate will include a door which often connotes a panel-like construction. Conventional arrangements for operating the landing doors and a car gate involve numerous control and power lines each often dedicated to a single door or gate and a single function. Traditional wiring arrangements can be expensive to install because of the physical labor, the materials used, and the frequency of wiring errors and faults, often not easily diagnosed or found, attendant with the use of numerous wires and connection points. Moreover, the raw bulk of numerous wires forces the use of relatively large conduit, duct, or piping to carry the required wires and these larger conduits, fittings, and accessories multiply the labor and material costs and general difficulty of an installation.

Serial communication is a relatively well understood and mature technology that has been used in various industrial applications. As a result of the recognized benefits of this technology, international standards have been adopted by industry participants to classify and describe the function, capability and protocol of commercially sold serial communication devices. As yet, as far as known, this technology has heretofore been unused in the freight elevator door and gate industry.

### SUMMARY OF THE INVENTION

The invention applies serial communication based techniques and hardware to the control of freight elevator car gates and landing doors. With the invention, considerable savings of installation time and materials are realized. Additionally, wiring mistakes and faults are potentially reduced by a reduction in wiring and the number of connections required to be made in the field. Diagnosis and troubleshooting of possible system errors and problems are facilitated by, inter alia, an ability to monitor the entire power and control circuitry from a central location and diagnosing and troubleshooting possible system errors and problems at each local floor or at the car. Typically, prior art arrangements required local system errors to be diagnosed at a central location upon simultaneous operation of each local floor zone switch. With the invention, commercially available serial communication master and slave units are integrated with signaling and actuator devices distributed at landings along the hoistway and on the car operating in the hoistway.

Locating the serial communication slaves at each landing and on a car in accordance with the invention, along with other appropriate hardware and control strategies, can significantly reduce the number of control lines and power lines required for freight elevator door and gate operation. Additionally, with the invention, the serial communication and selected componentry can be arranged to increase safety and reduce inadvertent bypassing or deliberate tampering of safety door locking strategies. It will be seen that the invention departs from the time honored convention of component control through individual dedicated electrical control and/or power lines.

### BRIEF DESCRIPTION OF THE DRAWINGS

FIGS. 1A and 1B show a schematic wiring diagram of a freight elevator door control installation representing an example of an application of the present invention; and

FIGS. 2A and 2B show a schematic wiring diagram illustrating an example of prior art freight elevator door control technology.

### DESCRIPTION OF THE PREFERRED EMBODIMENT

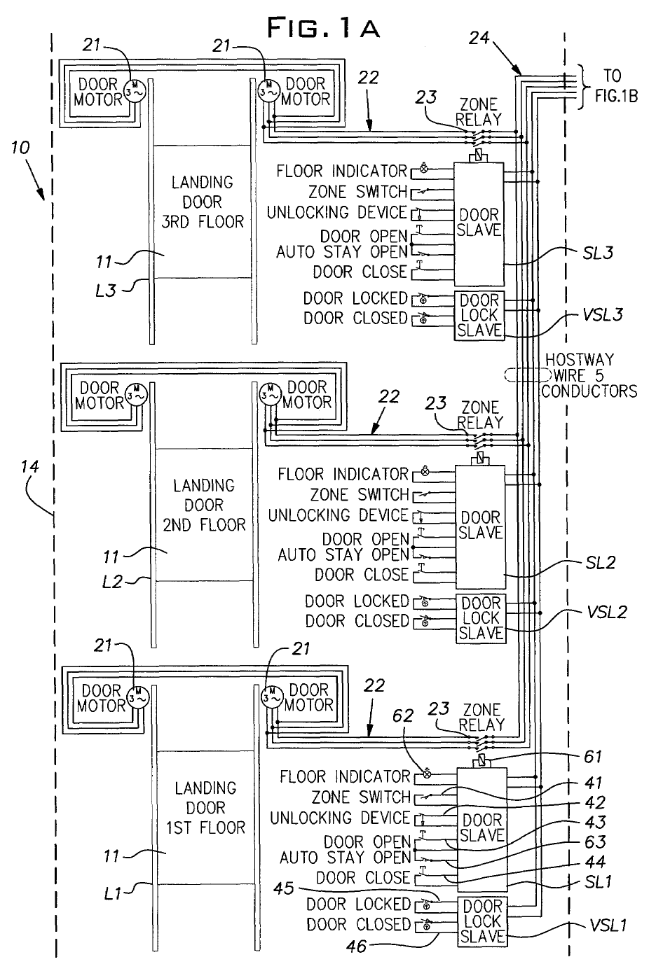

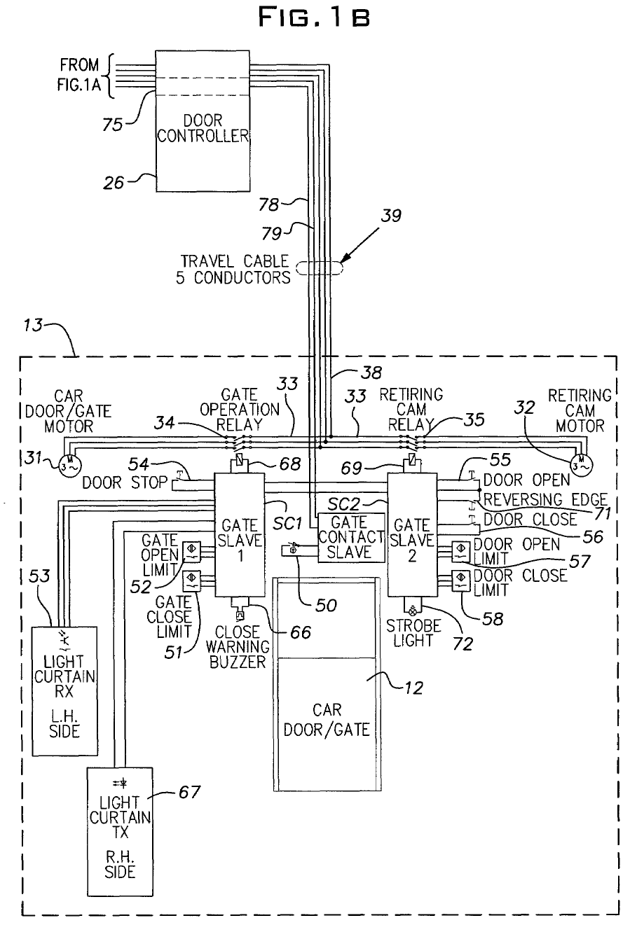

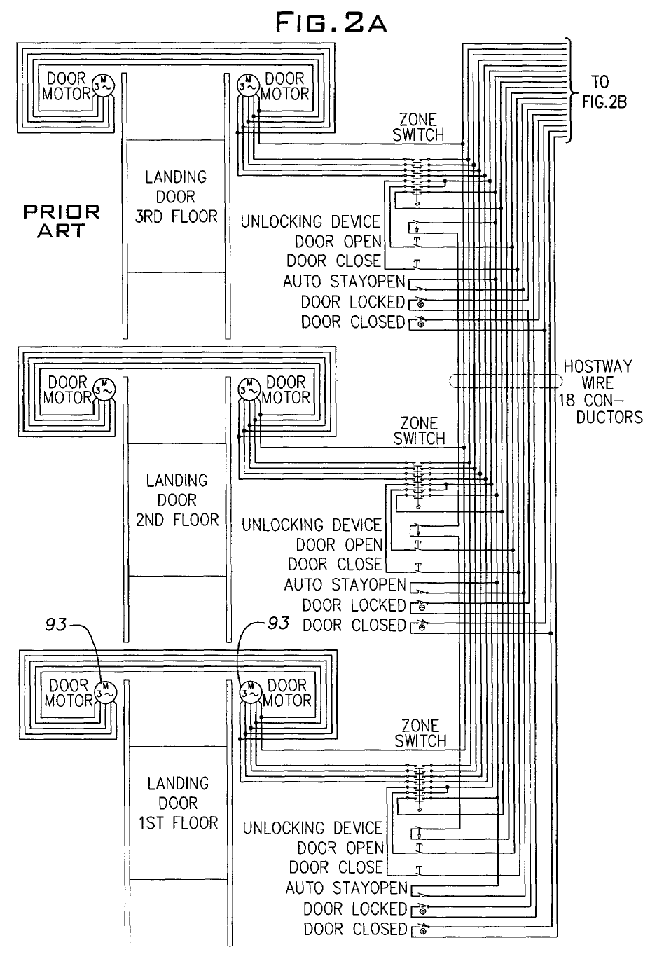

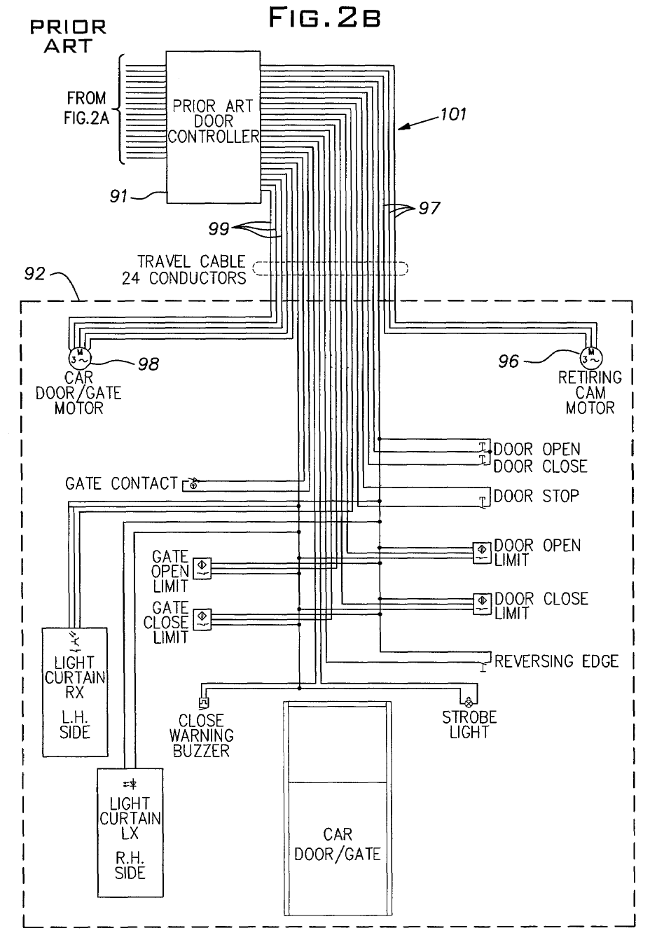

The invention is particularly suited for application to freight elevator installations 10 with vertically sliding powered landing doors 11 and at least one vertically sliding powered gate 12, such as that generally illustrated in FIGS. 1A and 1B. A freight elevator car 13 operating in a vertical hoistway 14 serves a plurality of landings L. Three landings L1, L2, and L3 are represented in FIGS. 1 and 2, but it will be understood that the invention is applicable to other numbers of landings. Moreover, it will be understood that the principles of the invention can be applied to installations where the landing doors and gates are provided at opposite ends or adjacent sides of the car.

For purposes of displaying the wiring and related componentry with clarity, the elevator car 13 in FIGS. 1 and 2 is shown away from the hoistway 14, but it will be understood that this is simply for these purposes and the elevator car operates in the hoistway. Vertically sliding doors 11 at the landings L, can be any of known types including bi-parting, and slide-up. Similarly, the car gate 12 is a vertically sliding type of known single or multiple panel construction including bi-parting types. Alternatively, the car and landings can be supplied with horizontally sliding gates and/or doors. Commonly, the gate 12 is formed from wire mesh, but can be of a solid panel or door design. The term gate, as used herein and as mentioned earlier, includes a door or door-like construction.

The doors 11 and gate 12 are guided for vertical movement on respective rails as is conventional. At each landing L, a door 11 is power operated up or down by a power operator 21. In the illustrated case, the power operator 21 is duplicated at each vertical edge of the landing door 11 but a single power operator for each door is also contemplated in practicing the invention. Each operator 21 preferably comprises a three-phase electric motor known in the art. The door operators or motors 21 are connected by wiring 22 through three pole relays 23, one relay for each pair of landing door operators 21, to a common power buss 24 supplying three phase electrical power across its three conductors. Power to the buss 24 is delivered under the control of a door and gate controller 26 such as a programmable logic controller (PLC). As is conventional, the door operators or motors 21 include drive sheaves or pulleys that raise or lower chains connected to their respective door 11 to open or close the same.

The elevator car 13 carries a gate operator 31 that comprises a three phase motor that lifts or lowers the gate 12 through a chain in a conventional manner. Another operator or three phase motor 32 on the elevator car 13 raises or lowers a retiring cam on the car that unlocks or locks the landing door 11 of the landing at which the car 13 is stopped. The operators or motors 31, 32 are both connected to three phase power carried on lines 33 through respective three pole relays 34, 35. Three phase electrical power is supplied to the lines 33 under the control of the controller 26. Typically, the controller 26 is situated in a machine room or other location apart from the car 13 and its path in the hoistway 14 but where desired or necessary can be situated at other locations including on top of the car or in the hoistway. Three phase power lines 38 run from the controller 26 and are part of a travel cable assembly 39 running to the elevator car 13 and the lines 33.

Powered movement or operation of a landing door 11 and powered movement or operation of the gate 12 relative to its car 13 is controlled by the controller 26 on the basis of the program under which it operates. The controller 26 relies on various signals it receives from sensors and push buttons at the landings L and on the car 13. A typical array of signal sources at a landing L include, in the order they are shown top to bottom in FIG. 1A, a zone switch 41, an unlocking device switch 42, a door open push button 43, an auto stay open switch 63, a door close push button 44, a door locked switch 45, and a door closed switch 46. Typical signal sources on the car 13, taken clockwise from the depiction in FIG. 1B, are gate close limit switch 51, gate open limit switch 52, light curtain interrupt detector 53, door stop push button 54, gate contact 50, door open push button 55, a reversing edge switch 71, door close push button 56, door open limit switch 57, and door close limit switch 58.

The controller 26, on the basis of its program and signals received from the just-mentioned sources, actuates components at the landings L and on the car 13 to open or close the doors 11 and the gate 12 as appropriate. These components typically include, at the landings L, a coil 61 for operating the relay 23, and a floor indicator light 62. On the car 13, the controller 26 operates a door close warning buzzer 66, a light curtain light source 67, a coil 68 for the car gate operator relay 34, a coil 69 for the retiring cam motor relay 35, and a strobe light 72.

The invention preferably involves the use of commercially available serial communication devices with components commonly referred to as slaves and masters to transmit control signals between the landings L and car 13 and the controller 26. One suitable class of serial control devices are those satisfying the AS-i (Actuator Sensor Interface) protocol such as marketed by Siemens® under product serial numbers F90, CP243, K45F, and 3RK1105. The enumerated sensing devices and activated or actuator devices are wired respectively, to input and output terminals of AS-i slaves SL1, SL2, and SL3 and verifying or fail safe slaves VSL1, VSL2, VSL3 associated with the landings L1, L2, and L3, and AS-i slaves SC1, SC2 and verifying or fail safe slave VSC, carried on the car 13. The landing slaves SL, VSL communicate with an AS-i master 75, via buss lines 76, 77, and the car slaves SC, VSC communicate with this master 75, via a pair of buss lines 78, 79. The master 75 is wired into the controller 26 to enable it to transfer sensor information to the controller and receive actuator command signals from the controller. The lines 78, 79 are part of the travel cable assembly 39. While the lines for communicating between the slaves SL, VSL and SC, VSC, and master 75, are displayed as electrical conductors, other communication techniques such as fiber optics and/or radio transmission are contemplated within the practice of the invention.

The master 75 receives signals from the slaves SL1, 2 and 3, VSL1, 2 and 3, and SC1 and 2 and VSC for the controller 26 and transmits actuator signals generated by the controller to the slaves. Serial communication technology is widely used and understood by those skilled in the art of automation. Serial communication enables numerous devices to be monitored and/or actuated remotely over a single pair of buss lines. This feature has great utility in freight elevator door and gate control as disclosed herein, because it greatly reduces the number of wires from that having been conventionally required to control the doors and car gate of a typical freight elevator system. Reducing the number of wires significantly lowers the labor involved in installing the hoistway conduit since the conduit can be smaller, lighter and easier to bend, and it along with fittings and accessories, is less expensive.

The serial communication hardware, in the form of the slaves on the car 13 (typically working with the same master that the landing slaves work with) affords a reduction in travel cable wires over prior art arrangements and here again achieves savings in material and installation labor. Still further, fewer wires require correspondingly fewer connections to be made in the field. The savings in connections is no trivial matter when it is realized that the wires need to be fished or otherwise set in place, stripped at their ends and be attached to appropriate connectors. This work is largely required to be done in the field under less than ideal working conditions. Additionally, the possibility of errors being made in wire connections is greatly reduced with the invention because the number of permutations of possible wire-to-wire or wire-to-terminal connections is reduced by what can be demonstrated to be enormous ratios.

Importantly, the invention further enhances the performance of the system by enabling the controller 26 to receive signals or data from numerous sensors to permit traditional functions and preferably additional functions to be safely managed by the controller even without adding to the number of control wires in the hoistway conduit or travel cable wire. For instance, by enabling the controller 26 to monitor the position of a car (sensed by the zone switch 41 at each landing, for example) and the activation of an unlocking device (sensed by the switch 42) at the relevant landing L where the car is absent, the controller can power the unlocked landing door by energizing the associated operator 21 through the corresponding relay 23. This departure from regular operation of the elevator system can typically occur during routine maintenance, inspection, or in the case of an emergency. At the same time, the controller 26 can maintain the power off to the operators of the other doors including the door of the landing where the car resides so as to ensure that only one landing door is opened under power at any given time. Moreover, if two unlocking devices, for example, are activated at the same time, the controller 26 can prevent power from being supplied to any of the door actuators. A significant advantage to routing all or at least the significant sensor output states to the controller 26 including the car position and the state of each of the landing doors and related sensing devices including closed, locked, and whether or not released by the unlocking device, permits any desired power shut-down format or strategy with the elevator system by the controller 26 that may be desired or appropriate. Further, the controller 26 can be used through the master 75 and slaves SL1-3 to open or close a selected landing door or doors remotely from a respective landing or landings independently of operation of door open or door close push buttons at the respective landing.

Freight elevator cars typically have devices called retiring cams that upon arrival at a landing extend to mechanically unlock a device which normally otherwise locks the landing door closed. The retiring cam operator 32 in the illustrated system comprises a three phase motor which operates in one direction to extend the cam and in the other direction to retract, i.e. retire the cam. The car gate operator 31 similarly comprises a three phase motor that rotates in one direction to open the gate 12 and in the opposite direction to close the gate. The car gate operator 31 and retiring cam operator 32 share the common set of three electric power lines of the travel cable 39. The retiring cam operation and gate operation do not occur at the same time. The controller 26, based in part on inputs from the sensor switches on the car and landings, energizes the retiring cam operator 32 at appropriate times through the relay 35 by way of the serial communication master 75 and car slave SC2 and energizes the car gate operator 31 at other appropriate times through the relay 34 by way of the same master and the slave SC1.

Troubleshooting the elevator car door/gate system is simplified over prior art arrangements since, among other reasons, faults at any of the landings can be reported to a single location, i.e. at the master 75 and/or the controller 26, and diagnosing and troubleshooting system errors and problems at each local floor or at the car is facilitated as well.

FIGS. 2A and 2B show a generalized schematic of a conventional wiring arrangement for controlling the landing doors and care gate of a freight elevator. With systems like that depicted in FIGS. 2A, 2B, numerous separate control lines must be run to each landing to monitor sensors, and there is no provision for remote electrical actuation of components through low voltage/low current control lines generated by signals from a controller 91. Importantly, in the prior art arrangement of FIG. 2, there is no provision to signal to the controller 91 the landing at which a car 92 is present. The controller 91 cannot determine if more than one unlocking device is deployed and for safety's sake must be programmed to shut off the power to all of the landing door operators, designated 93, if any one unlocking device is deployed, thereby making it difficult to open any door and only then by manual effort.

As FIGS. 2A, 2B show, control and operation of the elevator doors in a conventional manner requires a multiplicity of control lines and power lines. In the system of FIG. 2, the retiring cam actuator or motor 96 is operated by three power lines 97 and a car gate operator 98 is powered by an additional five power lines 99. These power lines 97 and 99 are part of a travel cable assembly 101. Unlike the arrangement disclosed in FIG. 1B, there is no provision on the car 92 to separately direct electrical power to one or the other of the retiring cam motor 96 or gate operator motor 98 from a common set of lines. Moreover, each of the electrical devices, in addition to the motors 96 and 98, requires at least one if not two wires for system operation, these wires being included in the travel cable assembly 101.

The system disclosed in FIGS. 1A, 1B lends itself to variable voltage variable frequency or VVVF technology such as marketed by Siemens® under the product serial number G110 to drive the landing door operators 21, gate operator 31, and retiring cam operator 32. The functions performed by these motors 21, 31 and 32, are augmented by their variable speed capacity when driven by a VVVF drive and, as known, these induction motors are reversible by switching connections of two of their field windings, i.e. connections to two of the three power lines running to these motors. This function is readily accomplished by the controller 26.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. An electrical control system for a freight elevator with vertically sliding electrically powered landing doors and at least one car gate, the system having sensors at each landing to detect the opened or closed condition and the locked or unlocked condition of the associated door, a sensor to detect the presence or absence of a car at each landing, a master controller for determining when to direct electrical power to a landing door operator and the direction to drive the powered operator to open or close the landing door, routes for communication between each of said sensors and the master controller, a path of electrical power for each landing door operator and controlled by said controller, the master controller being arranged to process data received from said sensors and being operable to select and energize the appropriate landing door operator during normal operation where a landing door operator is operated while the car is at its associated landing and in maintenance or emergency operation where a landing door operator is operated while the car is absent its associated landing, the master controller having the capacity to prevent powered operation of more than one landing door at any time regardless of mechanical over-riding or tampering with said sensor devices.

2. An electrical control system as set forth in claim 1, wherein said communication routes include a serial communication slave hardware at each landing and on the car, and a serial communication master responsive to and driving said slaves.

3. An electrical control system as set forth in claim 2, wherein the controller directs power to the door operators by communication between the serial communication slave hardware and master.

4. An electrical control system as set forth in claim 3, wherein said serial communication master and slave hardware are AS-i devices.

5. A freight elevator door installation including a plurality of vertically sliding landing doors and one or more vertically sliding car gates, each landing door and said gate being power driven by an associated electrically energized operator, serial communication slave hardware for each landing, and serial communication slave hardware on the car, a serial communication master arranged to receive and send control signals to both said landing and car slave hardware, a controller coupled with the serial communication master, a common pair of buss lines in the hoistway connecting each of the landing slaves to the master, the slave hardware for each landing being connected to sensors detecting the open and closed states and locked and unlocked states of the respective landing door and normal and deployed states of an unlocking device of the respective landing door, the slave hardware on the car being coupled to the master by lines associated with a travel cable.

6. A freight elevator door installation as set forth in claim 5, wherein each landing has a zone switch sensor responsive to the presence or absence of a car and connected to the associated slave hardware to enable the master in communication with the slaves to advise the controller of the same and the controller to thereby determine the location of the car.

7. A freight elevator door installation as set forth in claim 6, wherein door open and door closed push buttons at the landing are connected to the associated slave hardware to enable the controller to decide on the basis of communication between the respective slave and master whether to execute on the command of the push buttons.

8. A freight elevator door installation as set forth in claim 5, wherein the slave hardware associated with a landing is coupled to the master and controller in a manner enabling the controller to remotely open or close the landing door independently of operation of door open and door close push buttons at the respective landing.

9. A freight elevator door installation as set forth in claim 5, wherein said door actuators are three phase motors and said slave hardware controls three pole relays commonly connected to a three wire power buss for operation of all of said door actuators from said power buss.

10. A freight elevator door installation as set forth in claim 5, wherein said slave hardware on said car controls the operation of a gate operator and a retiring cam operator, said gate operator and retiring cam operator being driven by a common power buss carried in a traveling cable for said car, said car slave hardware being capable of alternatively actuating one or the other of the gate operator or retiring cam operator.

11. A freight elevator car having a vertically sliding door, an operator for power operating the door to open and close the same, a retiring cam operator for extending and retracting a retiring cam that unlocks or locks landing doors in the hoistway in which the car operates, a traveling cable assembly connected to the car extending from a stationary door controller and including electrical power lines, serial communication slave hardware on the car, a serial communication master associated with the elevator door controller and communicating with the slave hardware through the traveling cable assembly, an electrical control relay on the car for powering the gate operator by command signals issued by the door controller through the master to the slave hardware, an electrical control relay for powering the retiring cam operator by command signals issued by the door controller through the master to the slave hardware, the gate operator and retiring cam operator relays being commonly connected to said electrical power lines.
